(19) United States
(12) Patent Application Publication
(10) Pub. No.: US 2013/0176507 A1
(43) Pub. Date: Jul. 11, 2013

(54) TELEVISION AND ELECTRONIC APPARATUS

(71) Applicant: Yuji NAKAJIMA, Nishitama-gun (JP)

(72) Inventor: Yuji NAKAJIMA, Nishitama-gun (JP)

(73) Assignee: KABUSHIKI KAISHA TOSHIBA, Tokyo (JP)

(21) Appl. No.: 13/613,527

(22) Filed: Sep. 13, 2012

(30) Foreign Application Priority Data
Jan. 10, 2012 (JP) 2012-002479

(51) Int. Cl. H04N 5/64; G06F 1/16

(52) U.S. Cl. 348/836; 361/679.27; 348/E05.128

(57) ABSTRACT

According to one embodiment, an electronic apparatus includes a first housing, a second housing including a display, a first member configured to be rotatably connected to the first housing and the second housing, a second member configured to be rotatably connected to the first housing and the second housing, and a cable between the first housing and the second housing through the first member. The second member is configured to be substantially parallel to the first member. A length of the second member substantially is equal to a length of the first member. A center of rotation of the second member is configured to deviate from a center of rotation of the first member.

### CROSS-REFERENCE TO RELATED APPLICATIONS

This application is based upon and claims the benefit of priority from prior Japanese Patent Application No. 2012-002479, filed Jan. 10, 2012; the entire contents of which are incorporated herein by reference.

### FIELD

Embodiments described herein relate generally to an electronic apparatus including a television.

### BACKGROUND

Openable electronic apparatuses have been proposed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of a television according to a first embodiment;

FIG. 2 is an exemplary perspective view of an electronic apparatus according to a second embodiment;

FIG. 3 is an exemplary side view of the electronic apparatus illustrated in FIG. 2;

FIG. 4 is an exemplary side view of the open or closed state of the electronic apparatus illustrated in FIG. 2, (a) of FIG. 4 illustrating a state in which the opening or closing angle is 0°, (b) of FIG. 4 illustrating a state in which the opening or closing angle is 60°, (c) of FIG. 4 illustrating a state in which the opening or closing angle is 120°, and (d) of FIG. 4 illustrating a state in which the opening or closing angle is 170°;

FIG. 5 is an exemplary perspective view of the open or closed state of the electronic apparatus illustrated in FIG. 2, (a) of FIG. 5 illustrating a state in which the opening or closing angle is 0°, (b) of FIG. 5 illustrating a state in which the opening and closing angle is 60°, (c) of FIG. 5 illustrating a state in which the opening and closing angle is 120°, and (d) of FIG. 5 illustrating a state in which the opening and closing angle is 170°;

FIG. 6 is an exemplary cross-sectional view schematically illustrating the electronic apparatus illustrated in FIG. 2;

FIG. 7 is an exemplary enlarged cross-sectional view schematically illustrating a portion of the electronic apparatus illustrated in FIG. 2;

FIG. 8 is an exemplary enlarged cross-sectional view schematically illustrating a portion of the electronic apparatus illustrated in FIG. 2;

FIG. 9 is an exemplary perspective view of a first housing of the electronic apparatus illustrated in FIG. 2;

FIG. 10 is an exemplary enlarged perspective view of a portion of a keyboard illustrated in FIG. 9;

FIG. 11 is an exemplary perspective view of an electronic apparatus according to a third embodiment;

FIG. 12 is an exemplary perspective view of the open or closed state of the electronic apparatus illustrated in FIG. 11;

FIG. 13 is an exemplary perspective view of an electronic apparatus according to a fourth embodiment;

FIG. 14 is an exemplary cross-sectional view schematically illustrating the open or closed state of the electronic apparatus illustrated in FIG. 13; and

FIG. 15 is an exemplary cross-sectional view of the open or closed state of an electronic apparatus related to the first to fourth embodiments.

### DETAILED DESCRIPTION

Various embodiments will be described hereinafter with reference to the accompanying drawings.

In general, according to one embodiment, an electronic apparatus comprises a first housing, a second housing comprising a display, a first member configured to be rotatably connected to the first housing and the second housing, a second member configured to be rotatably connected to the first housing and the second housing, and a cable between the first housing and the second housing through the first member. The second member is configured to be substantially parallel to the first member. A length of the second member substantially is equal to a length of the first member. A center of rotation of the second member is configured to deviate from a center of rotation of the first member.

Hereinafter, embodiment will be described with reference to the accompanying drawings.

### First Embodiment

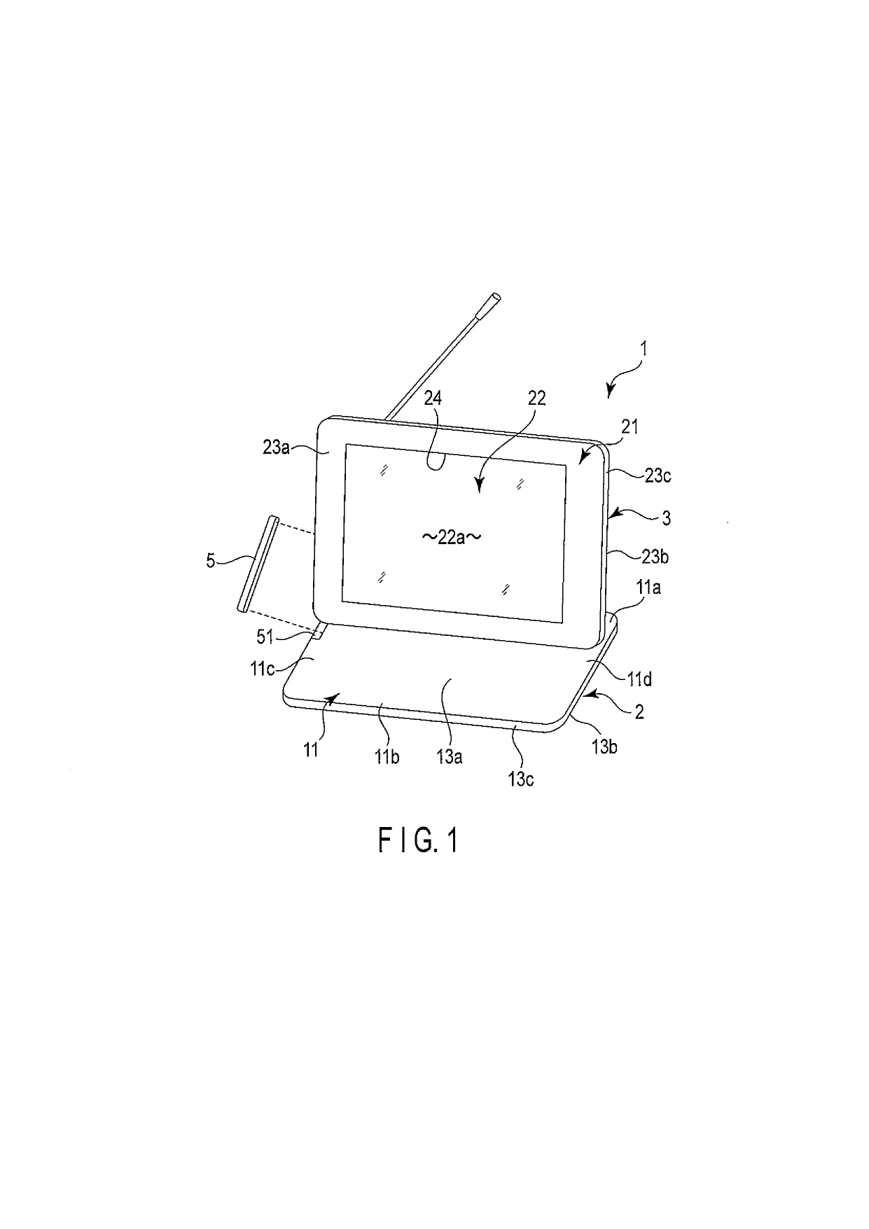

FIG. 1 illustrates a television 1 according to a first embodiment. The television 1 is an example of an “electronic apparatus”. The television 1 is, for example, a small portable television. The television 1 includes a first unit 2, a second unit 3, a first member 4, a second member 5, and a cable 6. The second member 5 is removable from the first unit 2 and the second unit 3.

The detailed structures of the components are substantially the same as those in a second embodiment. Therefore, the second embodiment will be described in detail. Components having the same or similar functions as those in the second embodiment are denoted by the same reference numerals and the description thereof will not be repeated.

### Second Embodiment

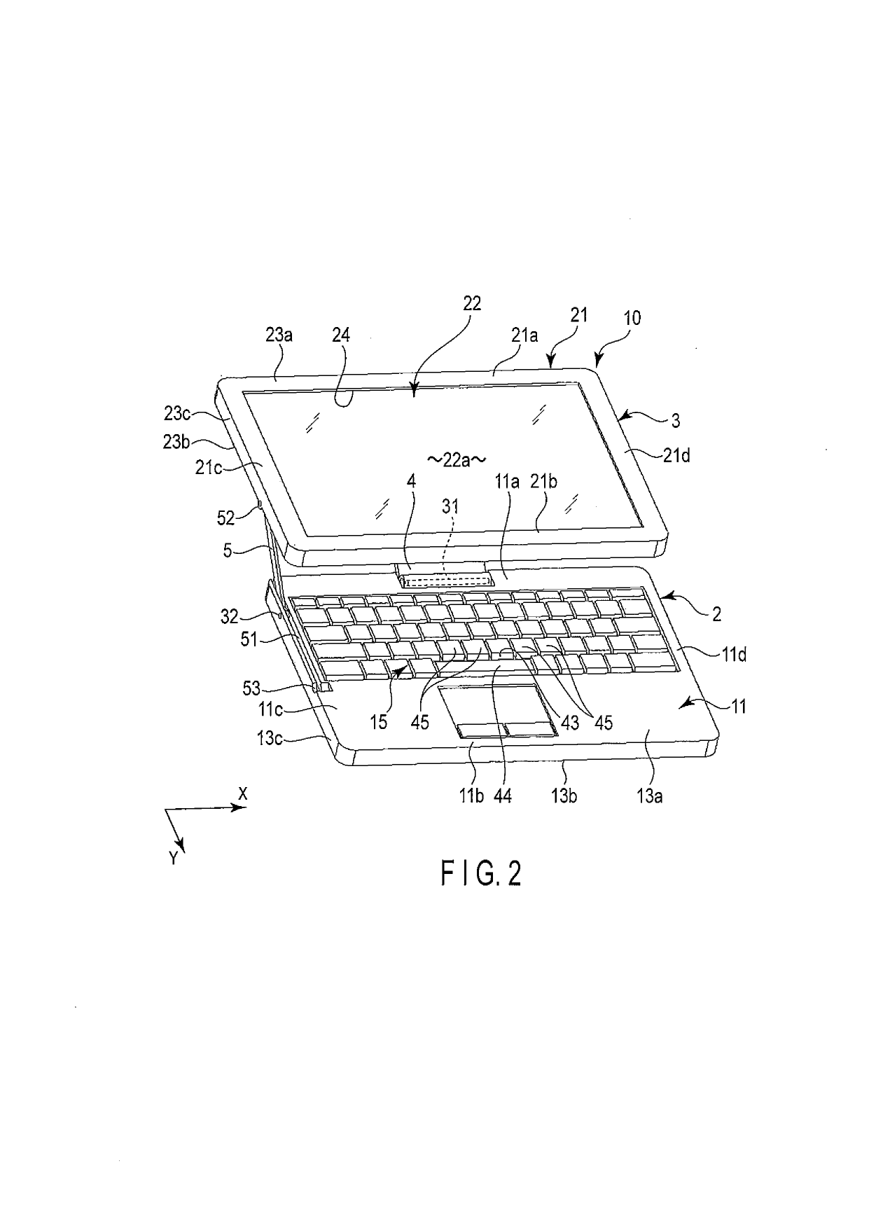

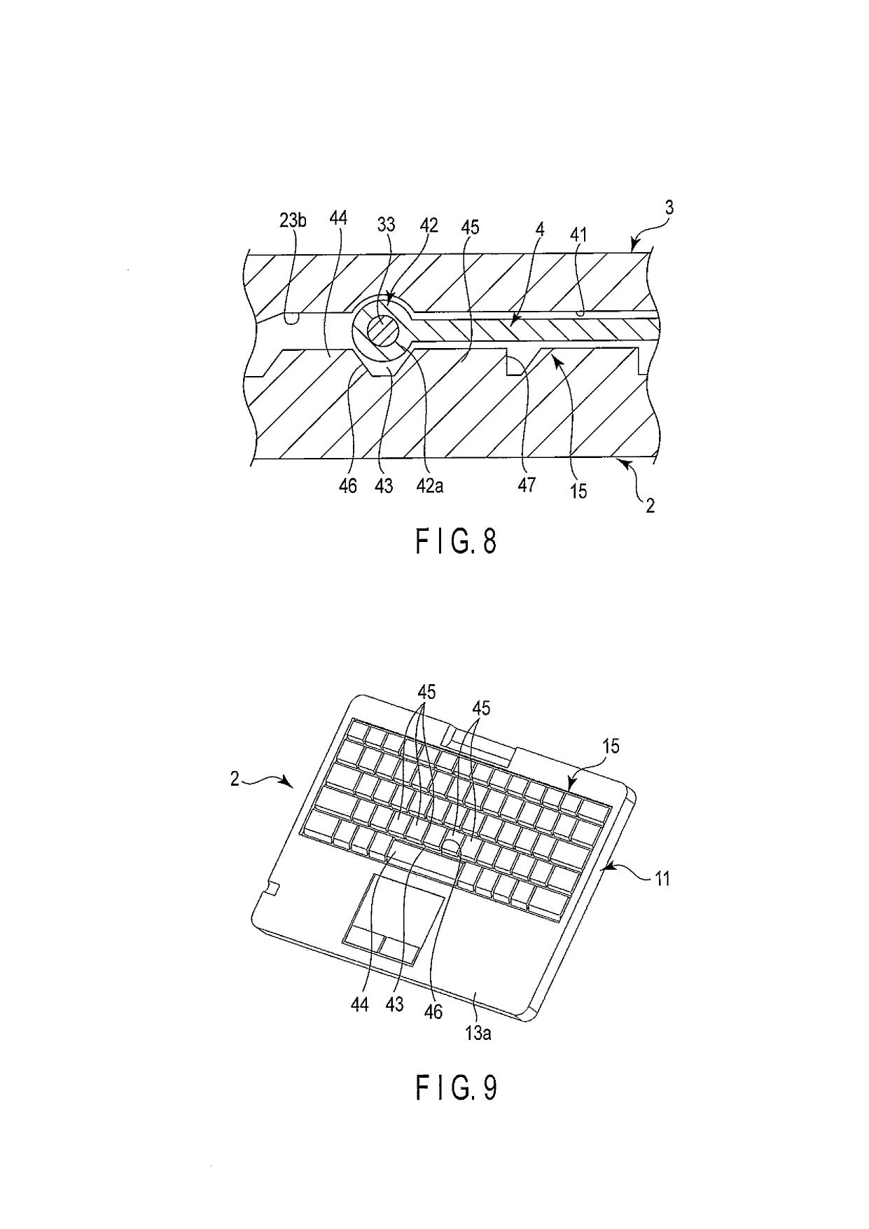

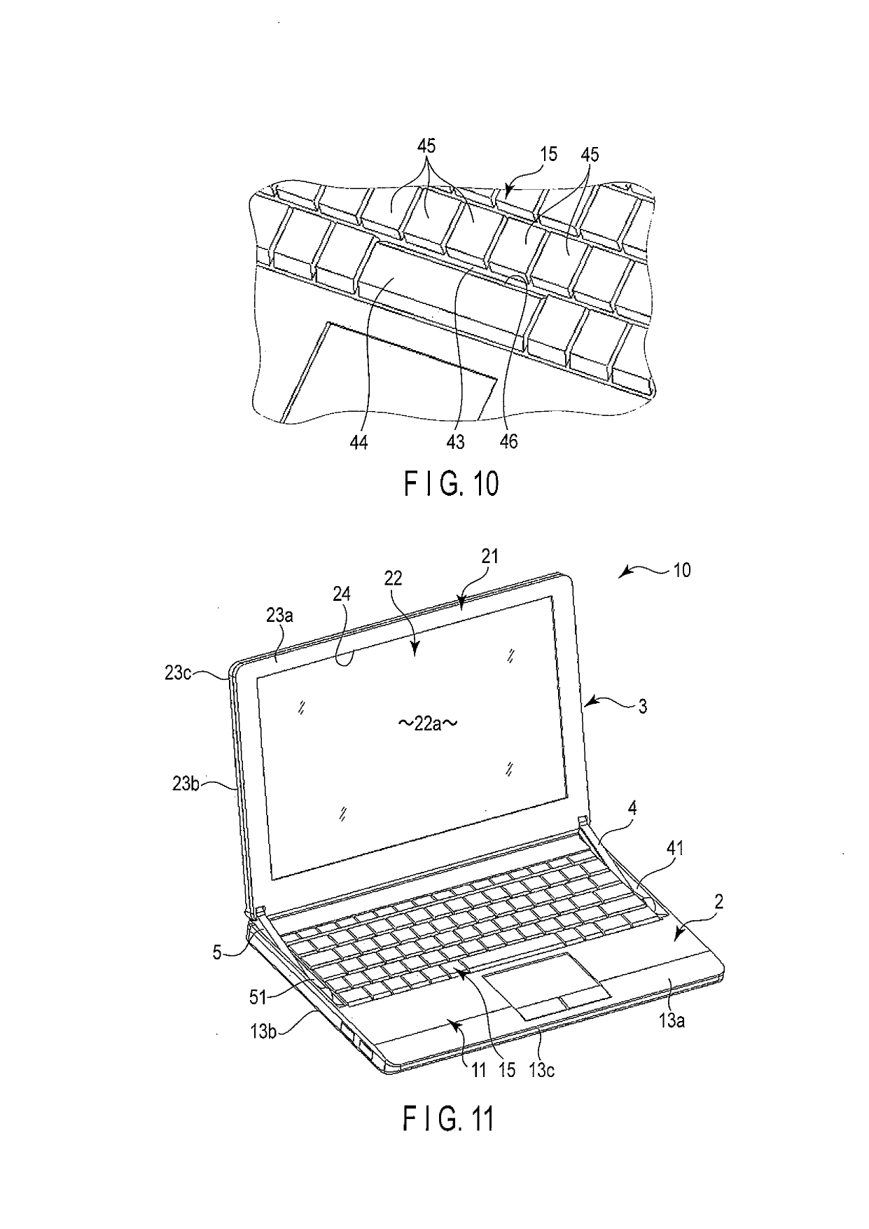

Next, an electronic apparatus 10 according to a second embodiment will be described with reference to FIGS. 2 to 10. The electronic apparatus 10 according to this embodiment is, for example, a notebook portable computer (i.e., notebook PC). The electronic apparatus 10 includes a first unit 2 and a second unit 3.

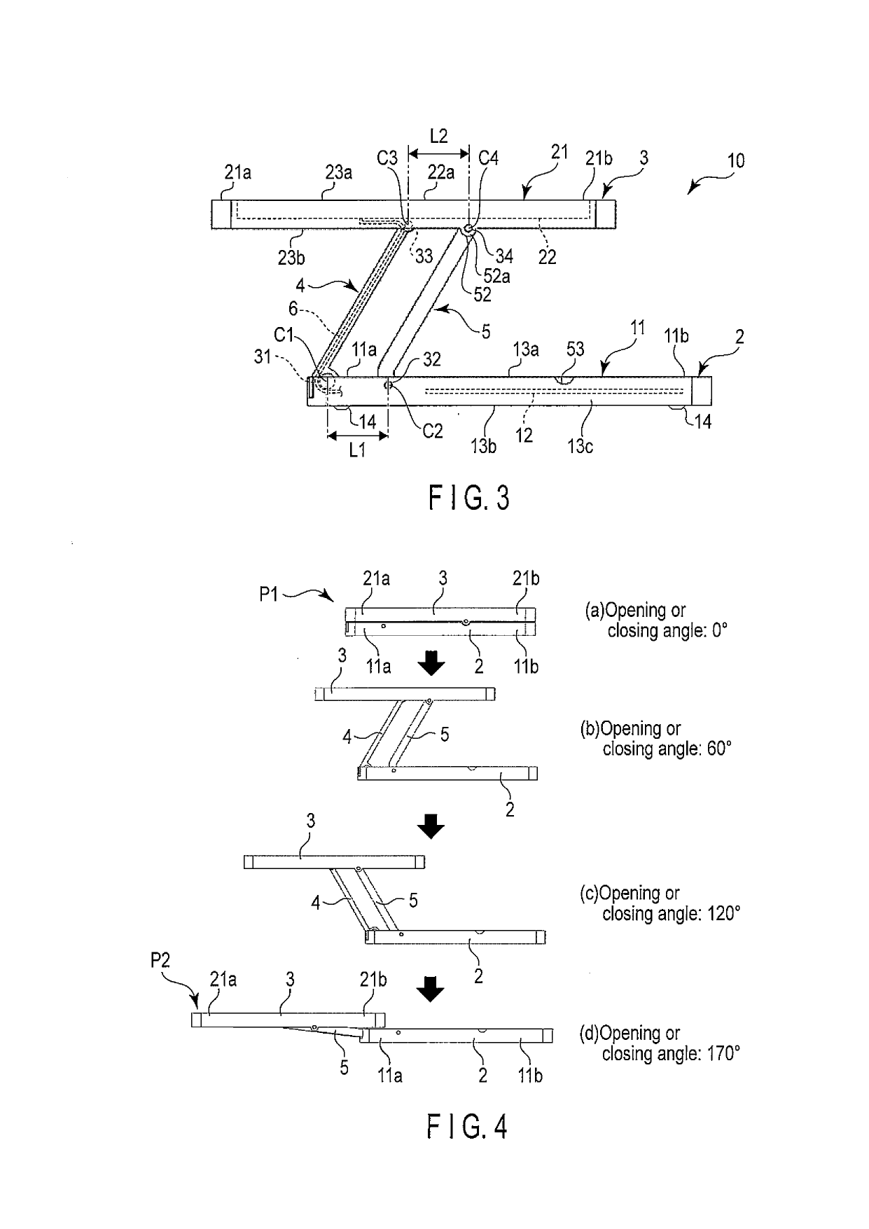

As illustrated in FIGS. 2 and 3, the first unit 2 is, for example, a main unit. The first unit 2 includes a first housing 11. The first housing 11 includes, for example, a circuit board 12 as a main board. The first housing 11 includes an upper wall 13a (i.e., upper surface), a lower wall 13b (i.e., lower surface), and a circumferential wall 13c (i.e., a circumferential surface or a side surface) and has a flat box shape. In the specification, the upper, lower, left, and right sides are defined in the viewing direction of the user. The side close to the user is defined as the “front side” and the side away from the user is defined as the “rear side”.

The lower wall 13b faces a desk surface (i.e., outer surface, mounting surface, or outer mounting surface) when the electronic apparatus 10 is placed on a desk. For example, a plurality of leg portions 14 (i.e., supporting portions) that come into contact with the desk surface are provided on the lower wall 13b. The upper wall 13a is opposite to the lower wall 13b with a space therebetween and extends substantially in parallel to the lower wall 13b. The circumferential wall 13c extends in a direction crossing the lower wall 13b and connects the edge of the lower wall 13b and the edge of the upper wall 13a.

A keyboard 15 is provided on the upper wall 13a. The keyboard 15 is an example of an input receiving portion (i.e., input portion). However, the input receiving portion is not limited thereto. For example, the input receiving portion may be a touch panel (i.e., touch sensor) or other input devices.

The first housing 11 includes a first end 11a, a second end 11b, a third end 11c, and a fourth end 11d. The first end 11a is, for example, the rear end and extends in the longitudinal direction (i.e., the width direction of a housing) of the first housing 11. The second end 11b is opposite to the first end 11a and is, for example, the front end. The second end 11b extends substantially in parallel to the first end 11a. The keyboard 15 is disposed between the first end 11a and the second end 11b.

Each of the third end 11c and the fourth end 11d extends in a direction crossing (e.g., substantially perpendicular to) the first end 11a. Each of the third end 11c and the fourth end 11d extends between the first end 11a and the second end 11b. The third end 11c is, for example, the left end. The fourth end 11d is opposite to the third end 11c and is, for example, the right end. Instead of the structure according to this embodiment, the third end 11c may be the right end and the fourth end 11d may be the left end.

The second unit 3 is, for example, a display unit. The second unit 3 includes a second housing 21. The second housing 21 includes a display device 22 (i.e., a display, a display module, or a display device). The display device 22 is, for example, a liquid crystal display (LCD), but is not limited thereto. The display device 22 includes a display screen 22a. The display screen 22a is provided with, for example, a touch panel (i.e., touch sensor) and has an input function (i.e., input receiving function). That is, the electronic apparatus 10 according to this embodiment has a tablet function.

The second housing 21 includes an upper wall 23a (i.e., upper surface), a lower wall 23b (i.e., lower surface), and a circumferential wall 23c (i.e., a circumferential surface or a side surface) and has a flat box shape. An opening 24 facing the display screen 22a is provided in the upper wall 23a. The display screen 22a is exposed to the outside through the opening 24. A space is formed between the lower wall 23b and the upper wall 23a, and the lower wall 23b extends substantially in parallel to the upper wall 23a. The circumferential wall 23c extends in a direction crossing the lower wall 23b and connects the edge of the lower wall 23b and the edge of the upper wall 23a.

The second housing 21 includes a first end 21a, a second end 21b, a third end 21c, and a fourth end 21d. The first end 21a is, for example, the rear end and extends in the longitudinal direction (i.e., the width direction of the housing) of the second housing 21. The second end 21b is opposite to the first end 21a and is, for example, the front end. The second end 21b extends substantially in parallel to the first end 21a.

Each of the third end 21c and the fourth end 21d extends in a direction crossing (e.g., substantially perpendicular to) the first end 21a. Each of the third end 21c and the fourth end 21d extends between the first end 21a and the second end 21b. The third end 21c is, for example, the left end. The fourth end 21d is opposite to the third end 21c and is, for example, the right end. Instead of the structure according to this embodiment, the third end 21c may be the right end and the fourth end 21d may be the left end.

As illustrated in FIGS. 2 and 3, the electronic apparatus 10 includes first to fourth shafts 31, 32, 33, and 34. Next, a first direction X and a second direction Y are defined. The first direction X is along the first end 11a of the first housing 11. The second direction Y intersects (e.g., substantially perpendicular to) the first direction X and is along the third end 11c of the first housing 11.

The first shaft 31 (i.e., first rotating shaft) is provided substantially at the center portion of the first end 11a of the first housing 11. The first shaft 31 is arranged along the first end 11a and extends in the first direction X. The second shaft 32 (i.e., second rotating shaft) is provided at the third end 11c of the first housing 11. The second shaft 32 is disposed between the keyboard 15 and the circumferential wall 13c (i.e., side surface) of the first housing 11.

The second shaft 32 is disposed between the first end 11a and the second end 11b of the first housing 11. The second shaft 32 is provided in front of the first shaft 31. That is, the second shaft 32 is closer to the second end 11b of the first housing 11 than the first shaft 31. The second shaft 32 is substantially parallel to the first shaft 31 and extends in the first direction X.

The third shaft 33 (i.e., third rotating shaft) is provided substantially at the center portion of the lower wall 23b of the second housing 21. The third shaft 33 is substantially parallel to the first shaft 31. The fourth shaft 34 (i.e., fourth rotating shaft) is provided at the third end 21c of the second housing 21. The fourth shaft 34 is disposed between the second end 21b and the center of the second housing 21. The fourth shaft 34 is provided in front of the third shaft 33. That is, the third shaft 33 is closer to the second end 21b than the fourth shaft 34. The second shaft 32 is substantially parallel to the first shaft 31 and extends in the first direction.

As illustrated in FIG. 3, a distance L1 (i.e., pitch) between the first shaft 31 and the second shaft 32 is substantially equal to a distance L2 (i.e., pitch) between the third shaft 33 and the fourth shaft 34. A line connecting the first shaft 31 and the third shaft 33 is substantially parallel to a line connecting the second shaft 32 and the fourth shaft 34.

As illustrated in FIGS. 2 and 3, the electronic apparatus 10 includes a first member 4 (e.g., a first supporting portion or a first connection portion) and a second member 5 (e.g., a second supporting portion or a second connection portion). The first member 4 is referred to as, for example, an arm. The second member 5 is referred to as, for example, a link (e.g., parallel link).

The first member 4 is provided so as to correspond to the center portion of the electronic apparatus 10 in the longitudinal direction and is rotatably connected to the first end 11a of the first housing 11 and the second housing 21. The first member 4 is provided at the center portion of the first end 11a of the first housing 11. The first member 4 is rotatably connected to the first shaft 31 and the third shaft 33.

The second member 5 is provided at the side end of the electronic apparatus 10 and is rotatably connected to the first housing 11 and the second housing 21. The second member 5 is provided along the keyboard 15 at the third end 11c of the first housing 11. The second member 5 is disposed between the keyboard 15 and the circumferential wall 13c (i.e., side surface) of the first housing 11. The second member 5 is rotatably connected to the second shaft 32 and the fourth shaft 34.

The second member 5 is substantially parallel to the first member 4. The length of the second member 5 is substantially equal to that of the first member 4. The second member 5 is thinner than the first member 4. The electronic apparatus 10 includes the cable 6 (e.g., a harness or an electric harness). The cable 6 passes through the first member 4 and extends between the first housing 11 and the second housing 21. The first end of the cable 6 is connected to, for example, the circuit board 12 in the first housing 11. The second end of the cable 6 is connected to, for example, the display device 22 or an antenna in the second housing 21.

As illustrated in FIGS. 2 and 3, the rotation center C2 of the second shaft 32 deviates from an extension line (i.e., axis line) of the rotation center C1 of the first shaft 31. The rotation center C4 of the fourth shaft 34 deviates from an extension line (i.e., axis line) of the rotation center C3 of the third shaft 33.

In this embodiment, the first member 4 and the second member 5 form a parallel link mechanism. The second housing 21 is supported by the first member 4 and the second member 5 and is movable relative to the first housing 11 between a first position P1 (i.e., first state) and a second position P2 (i.e., second state).

At the first position P1, the second housing 21 faces the first housing 11, and the display screen 22a is opposite to the first housing 11. The lower wall 23b of the second housing 21 covers the upper wall 13a of the first housing 11. The keyboard 15 of the first housing 11 is covered with the second housing 21 so as to be hidden from the outside.

At the second position P2, the second housing 21 deviates from the first housing 11. At the second position P2, the display screen 22a is exposed to the outside and the keyboard 15 of the first housing 11 is exposed to the outside. In this embodiment, the second end 21b (e.g., front end) of the second housing 21 overlaps the first end 11a (e.g., front end) of the first housing 11. In addition, the second housing 21 may not overlap the first housing 11 at all.

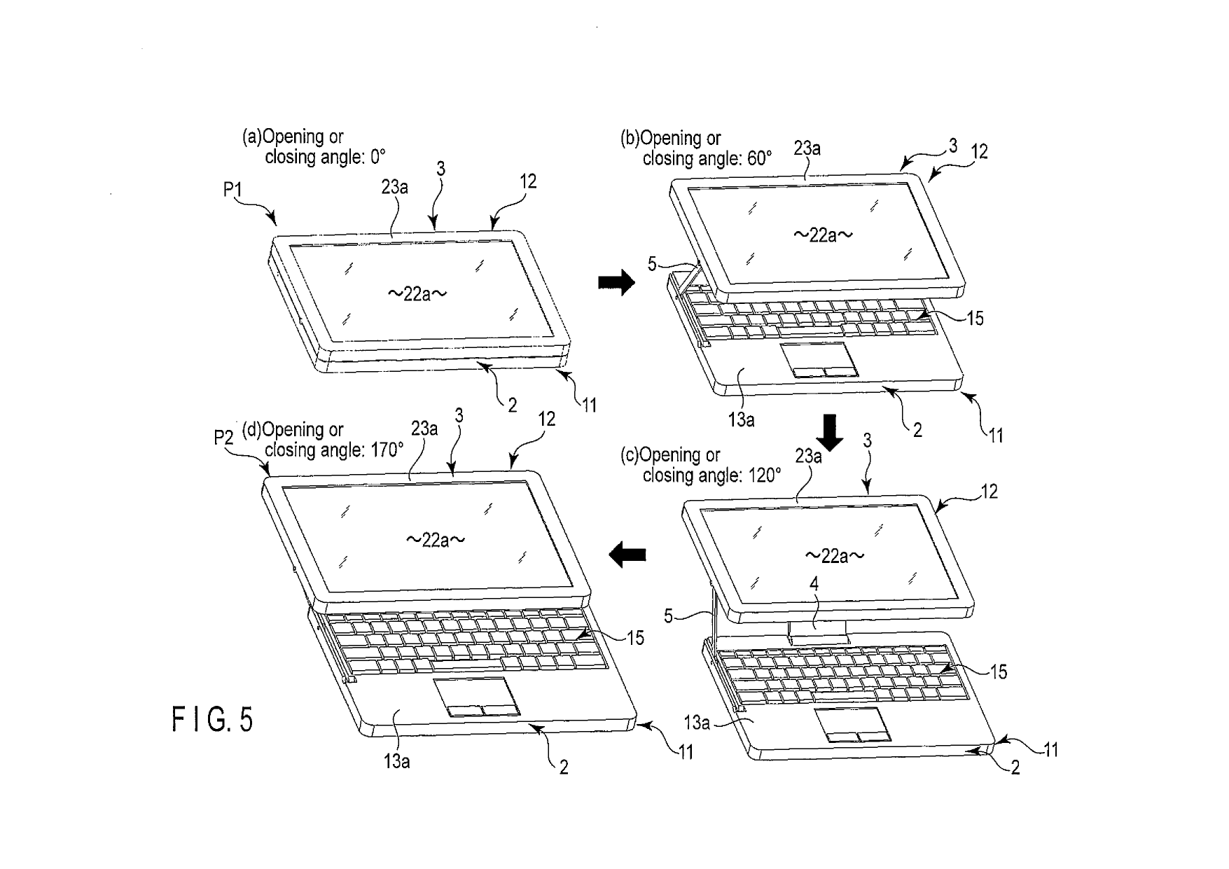

As illustrated in FIGS. 4 and 5, the second housing 21 is supported by the first member 4 and the second member 5 and is held and movable substantially in parallel to the first housing 11 between the first position P1 and the second position P2. That is, the second housing 21 and the first housing 11 are constantly substantially parallel to each other, regardless of the angle of the first member 4 and the second member 5.

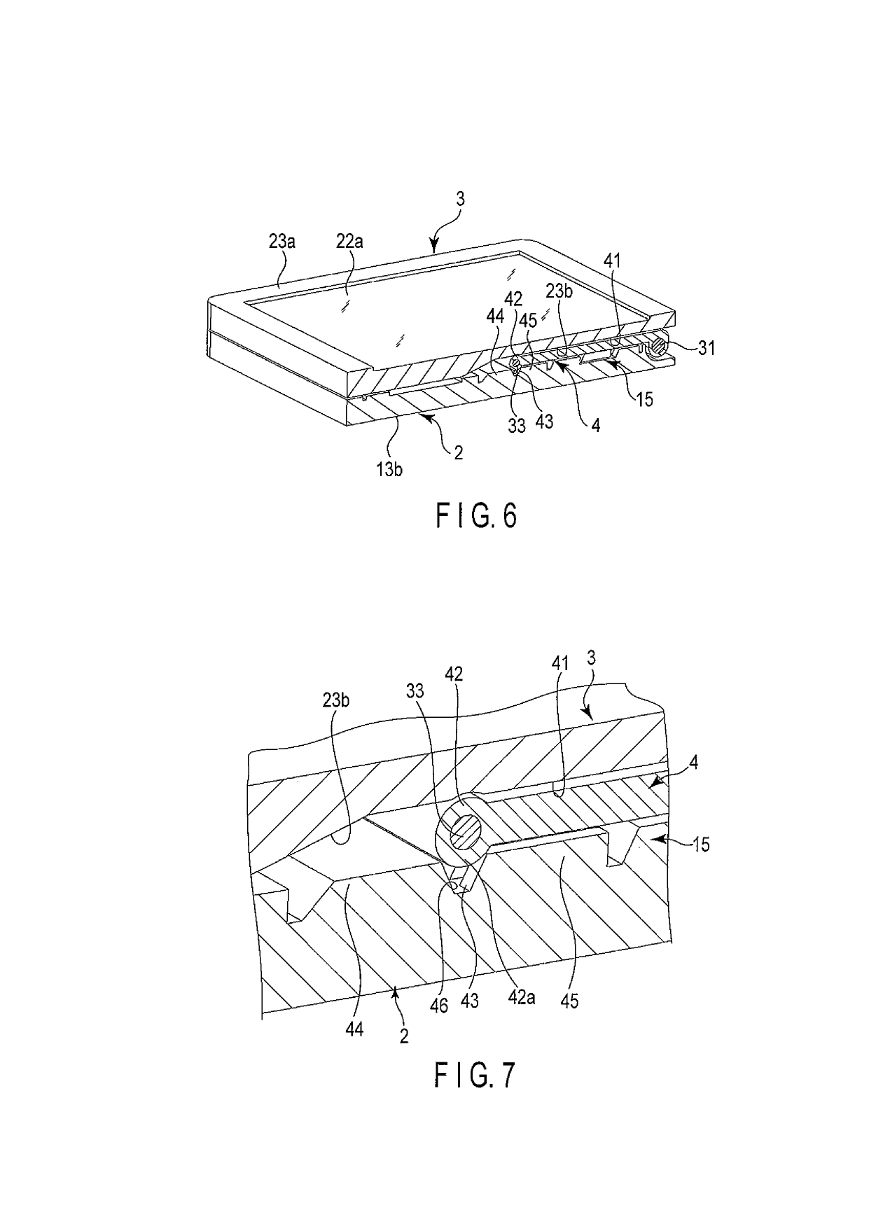

As illustrated in FIG. 6, a first groove 41 (e.g., an accommodating portion, a recess, or a recessed portion) is provided in the second housing 21. The first groove 41 extends in front of and in the back of the third shaft 33. The first groove 41 extends a predetermined distance from the third shaft 33 to the front side. The first groove 41 extends from the third shaft 33 to the rear side and reaches the first end 21a of the second housing 21. The third shaft 33 is provided in the first groove 41.

At the first position P1, at least a portion of the first member 4 is accommodated in the first groove 41. In this way, the first member 4 is disposed between the first housing 11 and the second housing 21. At the second position P2, a portion of the first member 4 is accommodated in the first groove 41.

As illustrated in FIGS. 6 to 8, the first member 4 includes a first shaft holder 42 (e.g., first bearing) which is rotatably attached to the third shaft 33. The first shaft holder 42 includes, for example, a cylindrical portion surrounding the third shaft 33. The first shaft holder 42 includes a projection 42a which protrudes from the lower wall 23b (i.e., lower surface) of the second housing 21 toward the first housing 11. The projection 42a faces the keyboard 15.

As illustrated in FIGS. 6 to 10, the keyboard 15 includes a first recess 43 (e.g., an accommodating portion or a recessed portion) into which the first shaft holder 42 (e.g., projection 42a) is inserted when the second housing 21 is at the first position P1. Specifically, the keyboard 15 includes a first key 44 and second keys 45. The second keys 45 are disposed between the first key 44 and the first end 11a of the first housing 11. Rows of the second keys 45 are disposed on the rear side of the first key 44 and are adjacent to the first key 44 from the rear side.

For example, an slope 46 which is obliquely cut is provided at the rear end of the first key 44. That is, the rear end of the first key 44 is chamfered. The slope 46 is inclined such that the distance between the first key 44 and the second keys 45 increases toward the second housing 21 (i.e., toward the upper side). The first recess 43 is formed by the gap between the slope 46 of the first key 44 and the second keys 45.

When the second housing 21 is at the first position P1, a part (e.g., projection 42a) of the first shaft holder 42 is accommodated between the slope 46 of the first key 44 and the second keys 45. The first key 44 is, for example, a space key. The space key is larger than other keys (e.g., the second keys 45). The space key is disposed substantially at the center of the first row of the keyboard 15. A keyboard center line (i.e., a center line between an F key and a J key) traverses the space key.

As illustrated in FIG. 2, a second groove 51 (e.g., an accommodating portion, a recess, or a recessed portion) is provided at the third end 11c of the first housing 11. The second groove 51 extends in front of and in the back of the second shaft 32. The second groove 51 extends from the second shaft 32 to the front side and has a length more than that of at least the second member 5. The second groove 51 extends from the second shaft 32 to the rear side and reaches the rear end of the first end 11a. The second shaft 32 is provided in the second groove 51.

At the first position P1, at least a portion of the second member 5 is accommodated in the second groove 51. In this way, the second member 5 is disposed between the first housing 11 and the second housing 21. At the second position P2, a portion of the second member 5 is accommodated in the second groove 51.

As illustrated in FIG. 2, the second member 5 includes a second shaft holder 52 (e.g., second bearing) which is rotatably attached to the fourth shaft 34. The second shaft holder 52 includes, for example, a cylindrical portion surrounding the fourth shaft 34. Therefore, the second shaft holder 52 includes a projection 52a which protrudes from the lower wall 23b (i.e., lower surface) of the second housing 21 toward the first housing 11. The projection 52a faces the third end 11c of the first housing 11.

As illustrated in FIG. 2, the first housing 11 includes a second recess 53 (e.g., an accommodating portion or a recessed portion) into which the second shaft holder 52 (e.g., projection 52a) is inserted when the second housing 21 is at the first position P1. A part (e.g., projection 52a) of the second shaft holder 52 is accommodated in the second recess 53.

According to this structure, it is possible to improve the durability of the electronic apparatus.

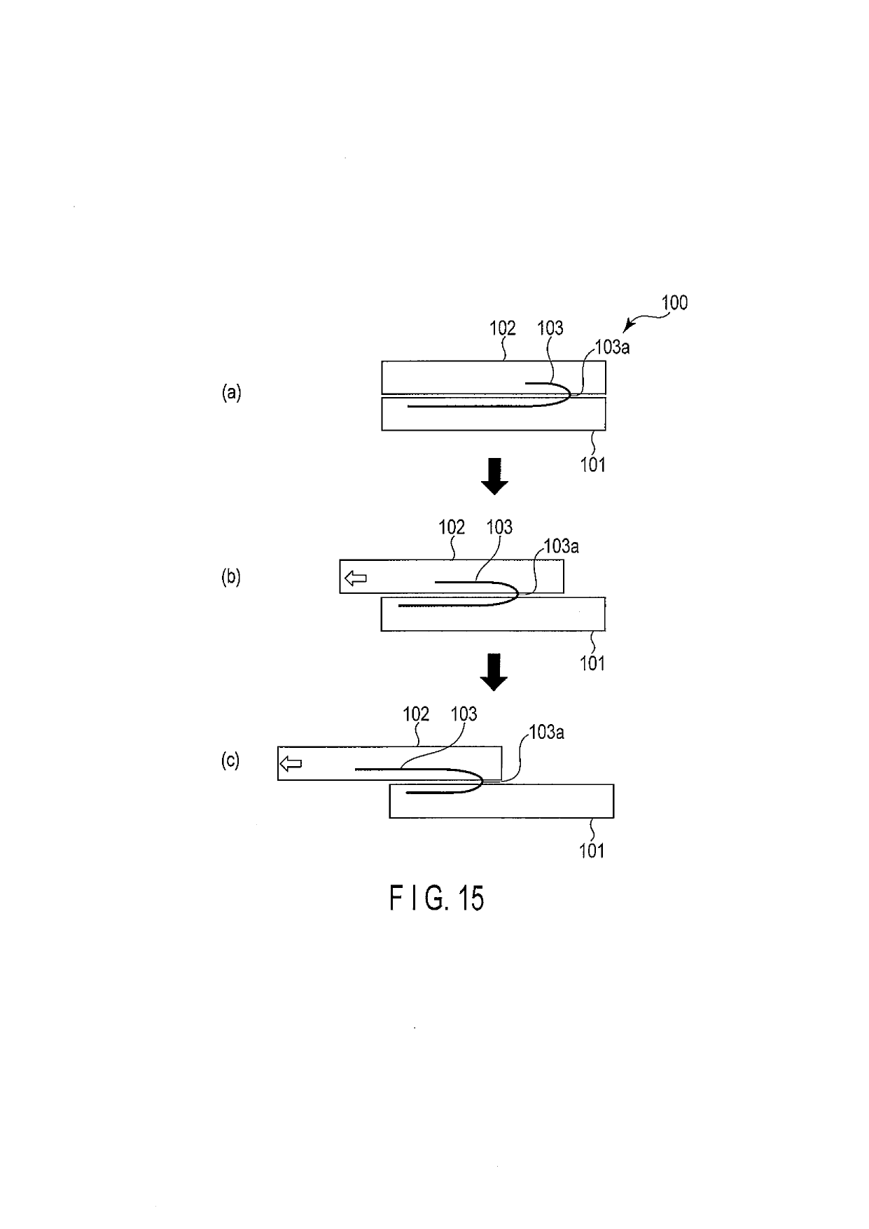

For comparison, FIG. 15 illustrates a slide-type electronic apparatus 100. The electronic apparatus 100 includes a first housing 101, a second housing 102, and a harness 103 which extends between the first housing 101 and the second housing 102. The harness 103 is bent substantially 180° between the first housing 101 and the second housing 102. When the second housing 102 slides relative to the first housing 101, a folding point 103a of the harness 103 is moved.

In recent years, the thickness of the electronic apparatus has been reduced. As the thickness of the electronic apparatus 100 is reduced, the bending of the harness 103 at the folding point 103a becomes stronger (e.g., the curvature radius of the harness 103 at the folding point 103a is reduced). When the second housing 102 slides relative to the first housing 101 in a state where the harness 103 is strongly bent, the harness 103 moves while the folding point 103a is stressed too much. Therefore, the harness 103 is damaged in a wide range and the life span of the harness 103 is likely to be reduced.

In contrast, in this embodiment, the electronic apparatus 10 includes the first member 4 and the second member 5 which are rotatably connected to the first housing 11 and the second housing 21, respectively. The second member 5 is substantially parallel to the first member 4 and has substantially the same length as the first member 4. The rotation center of the second member 5 deviates from the extension line of the rotation center of the first member 4. In this way, the electronic apparatus 10 can be moved between the first position P1 and the second position P2 by a rotary motion. For example, when the first member 4 is opened 170° to 180°, the first housing 11 contacts the second housing 21, which is substantially the same as the structure in which the slide-type electronic apparatus is opened.

In this embodiment, the cable 6 passes through the first member 4 and extends between the first housing 11 and the second housing 21. In the structure according to this embodiment, since the large movement is not made while stressing the folding point of the cable 6, the cable 6 is less likely to be damaged. Therefore, the durability of the electronic apparatus 10 is improved.

A general slide structure is affected by component tolerance. That is, when component tolerance is large (i.e., when backlash is large), the electronic apparatus does not smoothly slide. In some cases, the electronic apparatus is not smoothly opened. On the other hand, the rotary structure is less affected by component tolerance than the slide structure and it is expected that the rotary structure will be operated smoothly.

In this embodiment, the first member 4 is provided at the center portion of the first end 11a (e.g., rear end) of the first housing 11. In this way, it is easy to ensure a large width of the first member 4. When it is possible to ensure a large width of the first member 4, the flexibility of the cable 6 passing through the first member 4 is increased and the cable 6 is less likely to be damaged in the first member 4.

In this embodiment, the second member 5 is provided at the third end 11c of the first housing 11. In this way, it is possible to reduce the size of the electronic apparatus 10, as compared to the structure in which the second member 5 is provided on the side of the first housing 11.

In this embodiment, the first groove 41 in which at least a portion of the first member 4 is accommodated is provided in the second housing 21. In this way, when the first housing 11 and the second housing 21 overlap each other, the first member 4 is less likely to interrupt the overlap and it is possible to reduce the thickness of the electronic apparatus 10.

In this embodiment, the groove 51 in which at least a portion of the second member 5 is accommodated is provided at the third end 11c of the first housing 11. In this way, when the first housing 11 and the second housing 21 overlap each other, the second member 5 is less likely to interrupt the overlap and it is possible to reduce the thickness of the electronic apparatus 10.

The first member 4 includes the first shaft holder 42 connected to the third shaft 33. It is possible to reduce the size of the first housing 11 and the second housing 21, but there is a limit in reducing the thickness of the first shaft holder 42 due to the third shaft 33. In this embodiment, the first recess 43 in which a part of the first shaft holder 42 of the first member 4 is accommodated is provided in the keyboard 15 of the first housing 11. In this way, it is possible to reduce the thickness of the electronic apparatus 10.

In this embodiment, the keyboard 15 includes the first key 44 and the second keys 45. In general, the rear surface of the key of the keyboard is substantially perpendicular to the upper surface of the housing. In contrast, in this embodiment, the slope 46 which is inclined such that the distance between the first key 44 and the second key 45 increases toward the second housing 21 is provided at the rear end of the first key 44. The second recess 53 is defined by the gap between the slope 46 of the first key 44 and the second keys 45. For example, the inclination angle of the slope 46 is more than that of a rear surface 47 of the second key 45.

According to this structure, the first recess 43 is provided using the gap between the first key 44 and the second keys 45. In this way, it is possible to mount components with high density, as compared to a structure in which the first recess 43 is provided in a region other than the keys of the keyboard 15. Therefore, it is possible to reduce the size of the electronic apparatus 10.

In this embodiment, the first key 44 is a space key. In many cases, the space key is operated by the thumb. Therefore, even when the shape of the rear end of a key top is changed, the operability of the key is not substantially affected by the change in the shape of the rear end. From a different point of view, even when the shape of the rear end of the key top is changed, the operability of the key is not substantially affected by the change in the shape of the rear end since the space key is larger than other keys.

Similarly, the second member 5 includes the second shaft holder 52 connected to the fourth shaft 34. The second recess 53 in which a part of the second shaft holder 52 of the second member 5 is accommodated is provided at the third end of the first housing 11. In this way, it is possible to reduce the thickness of the electronic apparatus 10.

### Third Embodiment

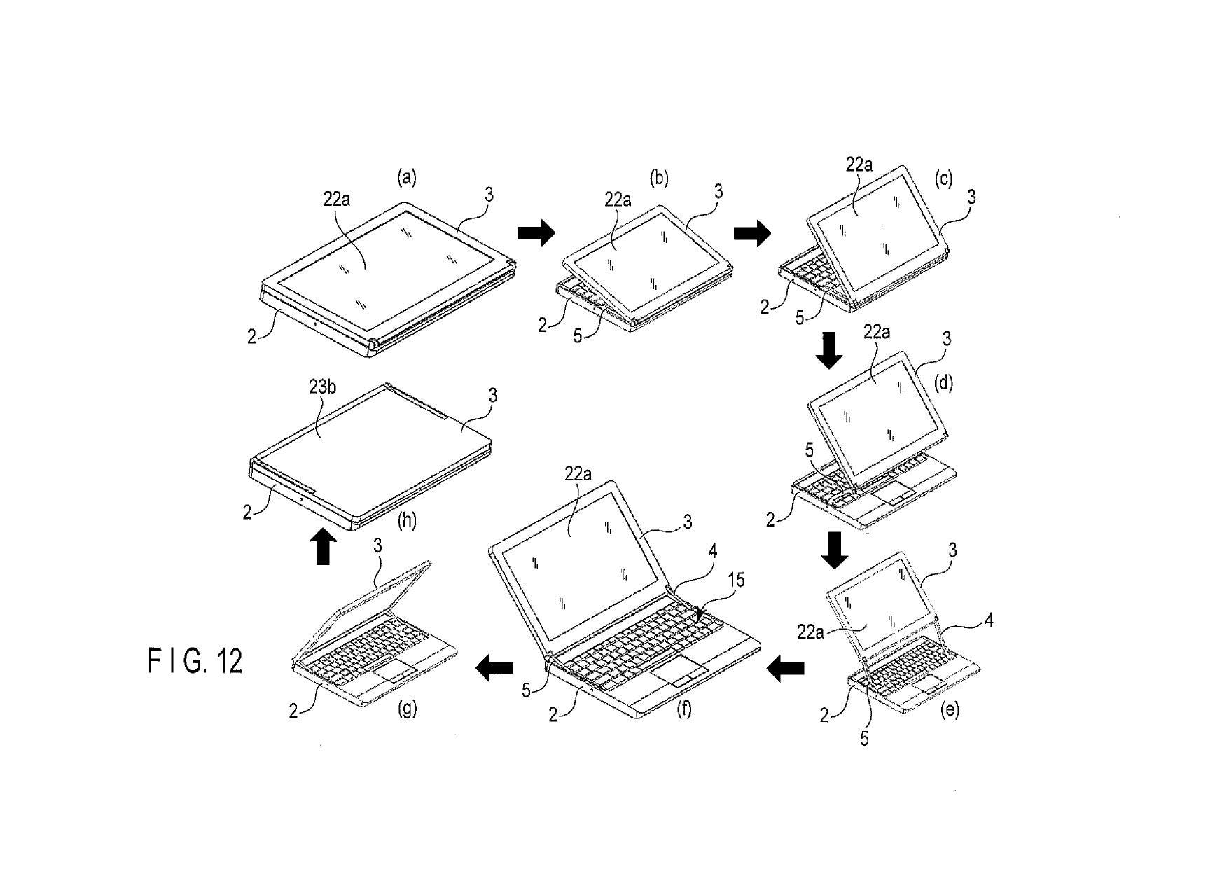

Next, an electronic apparatus 10 according to a third embodiment will be described with reference to FIGS. 11 and 12. In this embodiment, components having the same or similar functions as those in the second embodiment are denoted by the same reference numerals and the description thereof will not be repeated. In addition, structures other than the following structure are the same as those in the second embodiment.

The electronic apparatus 10 according to this embodiment differs from that according to the first embodiment in the attachment structure of a first member 4 and a second member 5. The first member 4 is provided at a fourth end 11d of a first housing 11. A second housing 21 is connected to the first member 4 and the second member 5 so as to be rotatable 180 degrees or more. A cable 6 passes through at least one of the first member 4 and the second member 5 and extends between the first housing 11 and the second housing 21.

As illustrated in FIG. 12, in this embodiment, the electronic apparatus 10 can be deformed among a first state ((a) of FIG. 12) in which a display screen 22a is exposed to the upper side, the first housing 11 and the second housing 21 overlap each other, and the electronic apparatus 10 can be used as a tablet PC, a second state ((f) of FIG. 12) in which the second housing 21 is opened from the first state, the first member 4 and the second member 5 are rotated, and electronic apparatus 10 has substantially the same structure as a notebook PC, and a third state ((h) of FIG. 12) in which the second housing 21 is closed from the second state and the electronic apparatus 10 has substantially the same structure as a closed notebook PC.

According to this structure, similarly to the second embodiment, the electronic apparatus can be deformed by a rotary motion. Therefore, since the large movement is not made while stressing the folding point of the cable 6, the cable 6 is less likely to be damaged. As a result, the durability of the electronic apparatus 10 is improved.

### Fourth Embodiment

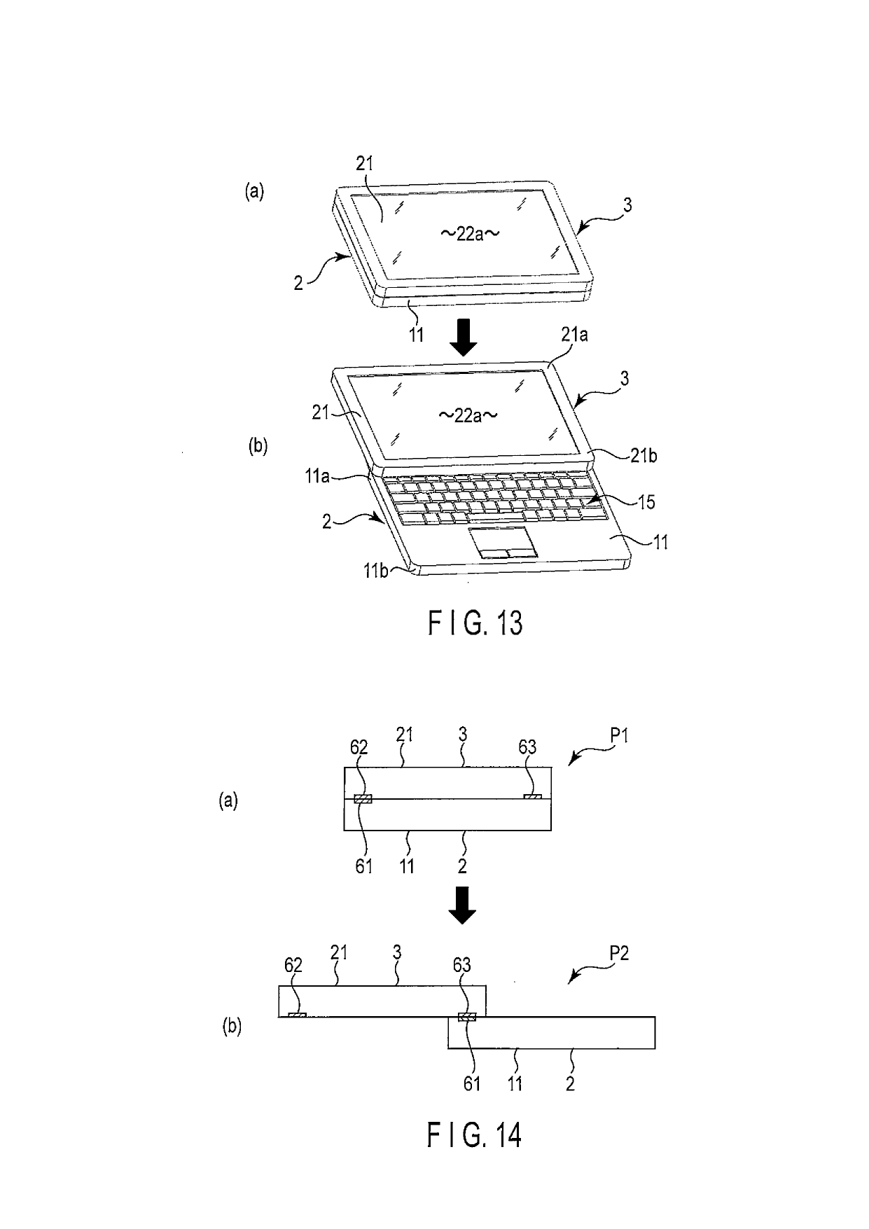

Next, an electronic apparatus 10 according to a fourth embodiment will be described with reference to FIGS. 13 and 14. In this embodiment, components having the same or similar functions as those in the second embodiment are denoted by the same reference numerals and the description thereof will not be repeated. In addition, structures other than the following structure are the same as those in the second embodiment.

As illustrated in FIGS. 13 and 14, in this embodiment, a second housing 21 can slide with respect to a first housing 11 between a first position P1 and a second position P2. At the first position P1, the second housing 21 and the first housing 11 overlap each other with a display screen 22a being opposite to the first housing 11. A lower wall 23b of the second housing 21 covers an upper wall 13a of the first housing 11. A keyboard 15 of the first housing 11 is covered with the second housing 21 and is hidden from the outside.

At the second position P2, the second housing 21 deviates from the first housing 11. At the second position P2, the display screen 22a is exposed to the outside and the keyboard 15 of the first housing 11 is exposed to the outside. In this embodiment, a second end 21b (e.g., front end) of the second housing 21 overlaps a first end 11a (e.g., rear end) of the first housing 11.

As illustrated in FIG. 14, in this embodiment, the electronic apparatus 10 includes first to third terminals 61, 62, and 63 (e.g., connection terminals, contacts, or electrical connection contacts), instead of the cable 6. The first terminal 61 is provided at the first end 11a of the first housing 11. The first terminal 61 is electrically connected to, for example, a circuit board 12 of the first housing 11.

The second terminal 62 is provided at the first end 21a of the second housing 21. The second terminal 62 is electrically connected to the display device or other components in the second housing 21. At the first position P1, the second terminal 62 comes into contact with the first terminal 61, and the second terminal 62 and the first terminal 61 are electrically connected to each other.

The third terminal 63 is provided at the second end 21b of the second housing 21. The third terminal 63 is electrically connected to the same component as the second terminal 62. At the second position 22, the third terminal 63 comes into contact with the first terminal 61, and the third terminal 63 and the first terminal 61 are electrically connected to each other. In this way, a first unit 2 and a second unit 3 are electrically connected to each other at both the first position P1 and the second position P2.

According to this structure, similarly to the second embodiment, since the large movement is not made while stressing the folding point of the cable 6, the cable 6 is less likely to be damaged. Therefore, the durability of the electronic apparatus 10 is improved.

According to the first to fourth embodiments, it is possible to improve the durability of the electronic apparatus. The electronic apparatuses to which the first to fourth embodiments can be applied are not limited to the notebook PC and the television, but the first to fourth embodiments can be widely applied to mobile phones (including smart phones) or other electronic apparatuses. In addition, the second member 5 (e.g., parallel link) may be removed.

The embodiments are not limited to the above-described embodiments, but the components according to the above-described embodiments may be changed without departing from the scope and spirit of the invention. In addition, a plurality of components according to the above-described embodiments may be appropriately combined with each other to form various structures. For example, some of the components according to the above-described embodiments may be removed. Components according to different embodiments may be appropriately combined with each other.

Next, an electronic apparatus based on a different point of view will be described. The electronic apparatus is manufactured in order to reduce, for example, the thickness.

The electronic apparatus comprises a first housing comprising an input receiving portion, a second housing, and a member configured to rotatably connect to the first housing and the second housing. The second housing comprises a shaft. The member comprises a holder attached to the shaft. The input receiving portion comprises a recess configured to receive a portion of the holder when the second housing and the first housing face each other.

According to this structure, it is possible to reduce the thickness of the electronic apparatus. In the electronic apparatus, the second member 5 may not be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a first housing comprising a first end and a second end, the second end opposite the first end;
a second housing comprising a display;
a first member configured to rotatably connect to the first end of the first housing and the second housing;
a second member configured to rotatably connect to the first housing and the second housing; and
a cable between the first housing and the second housing through the first member,
wherein the second member is configured to be substantially parallel to the first member, a length of the second member substantially equal to a length of the first member,
a center of rotation of the second member is configured to deviate from a center of rotation of the first member, and
the second housing is configured to be movable substantially in parallel to the first housing between a first position where the second housing faces the first housing with the display opposite the first housing, and a second position where the second housing is away from the first housing.

2. The television of claim 1,
wherein the first housing comprises a third end between the first end and the second end, and
the second member is configured to be at the third end.

3. The television of claim 2,
wherein the third end comprises a groove configured to receive at least a portion of the second member when the second housing is at the first position.

4. The television of claim 1,
wherein the first member is located substantially at the center portion of the first end.

5. An electronic apparatus comprising:
a first housing comprising a first end, a second end, and an input receiving portion, the second end opposite the first end;
a second housing comprising a display;
a first member configured to rotatably connect to the first end of the first housing and the second housing;
a second member configured to rotatably connect to the first housing and the second housing; and
a cable between the first housing and the second housing through the first member,
wherein the second member is configured to be substantially parallel to the first member, a length of the second member substantially equal to a length of the first member,
a center of rotation of the second member is configured to deviate from a center of rotation of the first member, and
the second housing is configured to be movable substantially in parallel to the first housing between a first position where the second housing faces the first housing with the display opposite the first housing and the input receiving portion covered by the second housing, and a second position where the second housing is away from the first housing and the input receiving portion is exposed.

6. The electronic apparatus of claim 5,
wherein the second member comprises a shaft holder configured to face the first housing, and
the input receiving portion comprises a recess configured to receive a part of the shaft holder when the second housing is at the first position.

7. The electronic apparatus of claim 6,
wherein the input receiving portion comprises a first key and a second key, the second key between the first key and the first end,
the first key comprises a slope facing the second key, and
the recess is between the slope and the second key.

8. The electronic apparatus of claim 7,
wherein the first key is a space key.

9. The electronic apparatus of claim 5,
wherein the first housing comprises a third end between the first end and the second end, and
the second member is thinner than the first member, the second member along the input receiving portion at the third end.

10. An electronic apparatus comprising:
a first housing;
a second housing comprising a display;
a first member configured to rotatably connect to the first housing and the second housing;
a second member configured to rotatably connect to the first housing and the second housing; and
a cable between the first housing and the second housing through the first member,
wherein the second member is configured to be substantially parallel to the first member, a length of the second member substantially equal to a length of the first member, and
a center of rotation of the second member is configured to deviate from a center of rotation of the first member.
